(19) United States
(12) Patent Application Publication
(10) Pub. No.: US 2009/0191922 A1
(43) Pub. Date: Jul. 30, 2009

(54) METHOD OF OPERATING A PORTABLE HANDS-FREE PHONE ACCESSORY

(75) Inventors: DANIEL S. ROKUSEK, LONG GROVE, IL (US); FIRAS S. KHASAWNEH, PALATINE, IL (US); MARK R. LEMKE, MUNDELEIN, IL (US); KEVIN L. WEIRICH, ALGONQUIN, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/021,440

(22) Filed: Jan. 29, 2008

(51) Int. Cl. H04M 1/00

(52) U.S. Cl. 455/569.2; 455/41.2

(57) ABSTRACT

A portable hands-free phone accessory (102) provides hands-free operation for a mobile communication device (104), and is operable in an operating mode for providing hands-free operation, and a low power, battery saving mode which does not provide hands-free operation. When the accessory is in the low power mode, it periodically checks to if a phone device has come within a hands-free range (204). When a phone device is detected, the accessory powers up for hands-free operation. When the accessory in the operating mode, and detects that the phone has moved away from the accessory (304), the accessory powers down to the low power mode.

### FIELD OF THE INVENTION

The invention relates generally to operation of portable hands-free phone accessories, and more particularly to reducing power consumption of such devices when the mobile communication device being supported is moved away from the device such that hands-free operation is no longer needed, and further to turning on the portable hands-free phone accessory when in a low power mode and a supported mobile communication device comes within sufficient range of the portable hands-free phone accessory.

### BACKGROUND OF THE INVENTION

A portable hands-free phone accessory is a device which allows “hands-free” operation of a phone device such as a mobile communication device. The portable hands-free phone accessory links with the phone device to replicate audio signals such that the user doesn't need to hold the phone device to their head. Hands-free operation therefore allows people to communicate while performing other activities with more ease. A common use for a hands-free phone accessory is as an in-vehicle speakerphone. Some vehicles are manufactured with integrated hands-free systems, but there is still a substantial number of new vehicles and older vehicles which have no such integrated system. As a result, there are a number of portable hands-free phone accessories for use in vehicles, and elsewhere.

Being portable, a portable hands-free phone accessory is typically battery powered. A common problem with these devices is that the user forgets to turn them off when, for example, leaving a vehicle in which the device is located, which unnecessarily depletes the charge of the hands-free device's battery. A further problem with the use of portable hands-free phone accessory devices is that the user may move away from the accessory device while a link is still maintained between the phone and the accessory device. When a call comes in to the phone, the phone will ring normally, but if the user answers the call at the phone, the audio is still being routed to the accessory device, so the user may not hear the person calling, or the person calling may not be able to hear the user, or both. Therefore there is a need for a means by which the portable hands-free accessory device can detect that it is no longer needed, and then shut itself down to a low power operating mode.

Likewise, when a person gets into their vehicle, it would be beneficial if the portable hands-free phone accessory could turn itself on, and provide hands-free operation, if so desired by the user. Accordingly, there is a corresponding need by which the portable hands-free phone accessory can determine that it will be needed, and power up from a low power mode to an operating mode.

### SUMMARY OF THE INVENTION

The present invention discloses a method for operating a portable hands-free phone accessory in powering down when no longer needed, and power up automatically when hands-free operation of a supported mobile communication device may be needed. One embodiment of the invention commences while the portable hands-free phone accessory is not connected to a phone and is operating in a low power mode by detecting at least one of a vibration of the portable hands-free phone accessory or a radio signal indicating the presence of a mobile communication device. The vibration may correspond to that caused by a vehicle door closing. Upon detecting the vibration or radio signal the method then commences powering up the portable hands-free phone accessory to an initial operating mode, and connecting to a mobile communication device over a wireless personal area radio link. Subsequently the portable hands-free phone accessory begins providing hands-free phone operation for the mobile communication device.

In another embodiment of the invention there is provided a method for operating a portable hands-free phone accessory commenced upon providing hand-free operation for an mobile communication device to which the portable hands-free phone accessory is wirelessly connected via a personal area network link. While in the hands-free mode, the portable hands-free phone accessory detects the occurrence of a condition indicating the mobile communication device has moved away from the portable hands-free phone accessory, and outside of a range corresponding to a vehicle cabin range. In response, the method then commences by powering the portable hands-free phone accessory down from an operating power level to a low power level, wherein the portable hands-free phone accessory cannot provide hands-free operation while in the low power mode.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a block schematic of a portable hands-free phone accessory and an associated mobile communication device, in accordance with an embodiment of the invention;

FIG. 2 shows a flow chart diagram of a method of operating a portable hands-free phone accessory device in accordance with one embodiment of the invention; and

FIG. 3 shows a flow chart diagram of a method of operating a portable hands-free phone accessory in accordance with an embodiment of the invention.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

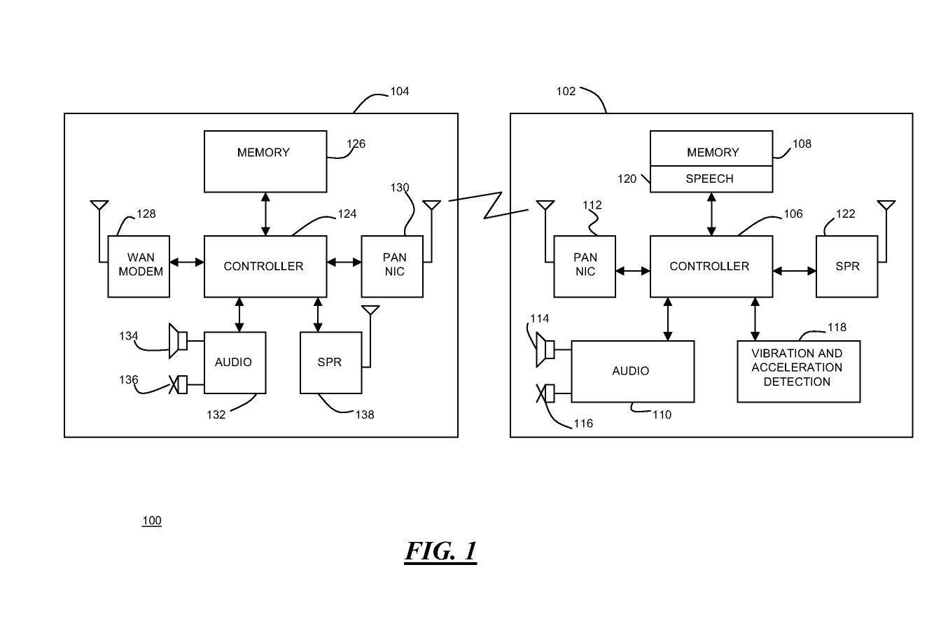

Referring now to FIG. 1, there is shown a block schematic diagram 100 of a portable hands-free phone accessory 102 and an associated phone device 104. The portable hands-free phone accessory 102 provides hands-free operation of the phone device 104. Specifically, audio signals received at the phone device are routed to the portable hands-free phone accessory to be played over a speaker of the portable hands-free phone accessory, and acoustic signals received at the portable hands-free phone accessory are converted to electrical signals, digitized, and sent to the phone device. The portable hands-free phone accessory and the phone device may be connected via conventional means, such as a wireless personal area network link. An example of a personal area network link may be a wireless link established in accordance with the air interface known by the trade name “Bluetooth,” and which is specified by the Institute of Electrical and Electronic Engineers (IEEE) standard 802.15.

The portable hands-free phone accessory comprises a controller 106 which is programmed with instruction code stored in a memory 108. The controller may be any suitable microprocessor or microcontroller, or other suitable logic processor. The memory may be any combination of read only memory, random access memory, reprogrammable memory and so on. The controller carries out instructions which are designed to operate the portable hands-free phone accessory in accordance with the teachings herein, as well as additional functions which may be beyond the scope of the invention. The portable hands-free phone accessory includes an audio processor 110 which processes audio signals received from the phone device, and acoustic signals received at the portable hands-free phone accessory. The signals received from the phone device will typically be digitized signals which need to be converted to analog signals by the audio processor 110 and played over a speaker 114 or other audio transducer. Similarly, the portable hands-free phone accessory has a microphone 116 for receiving acoustic signals such as, for example, the voice of the user when speaking, and coverts the resulting electrical analog signal to a digitized signal which may be routed to the phone device. To send and receive signals with the phone device, the portable hands-free phone accessory includes an interconnection means, such as a personal area network (PAN) network interface controller (NIC) 112. The NIC 112 controls access to the transmission medium and controls operation of the transceiver according to established interface protocol.

In order to power from a low power or sleep mode to an operating mode, and vice-versa, the portable hands-free phone accessory must be able to determine the absence or presence of the phone device, or infer its absence or presence and prompt for confirmation. Since the portable hands-free phone accessory is typically used as a speakerphone in a vehicle, the invention uses the vibration of a car door shutting to trigger the change in mode. Accordingly, the portable hands-free phone accessory may comprise an acceleration or vibration detection means 118. A common vibration sensing means is an array of micro-electromechanical switches or systems (MEMS). A MEMS array allows the characterization of vibrations experienced by the device in which they are mounted. Using three MEMS sensors aligned in each of three axes allows three dimensional vibration characterization. The vibration experienced by the portable hands-free phone accessory inside a vehicle caused by closing a vehicle door can be generally characterized, and stored as a vibration profile in the memory 108. Upon detecting a vibration or acceleration, the controller can store measurements and compare them in magnitude and time with the vibration profile corresponding to the closing of a vehicle door. It may be assumed that the closing of the vehicle door occurs in conjunction with a person entering or exiting the vehicle. The portable hands-free phone accessory may request confirmation of such since the vibration detection may arise from other similar vibrations, such as a passenger door closing. For example, a synthesized voice prompt may be generated from speech information 120 stored in the portable hands-free phone accessory. The prompt may ask the user to take an action or otherwise respond in a way that is detectable by the portable hands-free phone accessory. A lack of response indicates the user, and therefore a phone device, are not nearby.

Without the benefit of an accelerometer, the portable hands-free phone accessory may use the microphone 116 to detect the sound of a vehicle door closing. As with vibration, the acoustic signature of a vehicle door closing may be generally characterized and compared against sounds received at the portable hands-free phone accessory when the portable hands-free phone accessory is not engaged in a call.

An alternative method of detecting movement of the phone device away from the portable hands-free phone accessory is through the use of positioning information, as obtained, for example, by a satellite positioning receiver (SPR) 122. An SPR informs the portable hands-free phone accessory of its present location, as determined by receiving positioning signals transmitted by positioning satellites. The portable hands-free phone accessory may periodically receive location information from the phone device, assuming it is likewise equipped to determine its present location. The portable hands-free phone accessory may compare its location with the location of the phone device, and determine that the phone device has moved into or out of a range corresponding to a vehicle cabin range.

The phone device 104 may be a mobile communication device, such as a cellular telephone or similar device. It will typically include a controller 124 operating in conjunction with instruction code stored in a memory 126, and may include a wide area network modem 128 for communicating with wide area wireless networks, such as cellular networks. The mobile communication device also includes a PAN network interface controller 130 for communicating with nearby devices wirelessly, including the portable hands-free phone accessory. The mobile communication device also includes an audio processor 132 for playing audio signals over a speaker 134, and for converting acoustic signals received at a microphone 136 to electrical signals which are typically digitized.

In operation, the portable hands-free phone accessory is first paired with the mobile communication device over the PAN link. Pairing involves the portable hands-free phone accessory storing an identifier of the mobile communication device's PAN network interface controller in memory, and upon power up to an operating mode, searching PAN signals for that identifier, while ignoring signals from other devices. Once both the mobile communication device and portable hands-free phone accessory are powered up and linked, the portable hands-free phone accessory can provide hands-free operation for the mobile communication device. Upon commencement of a call, the call audio is processed by the portable hands-free phone accessory, rather than the audio processor 132 of the mobile communication device, generally.

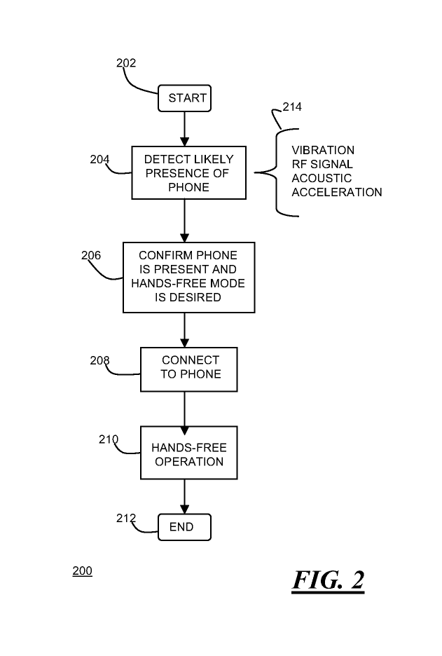

Referring now to FIG. 2, there is shown a flow chart diagram 200 of a method of operating a portable hands-free phone accessory, in accordance with an embodiment of the invention. In particular, the method shown represents a situation where, at the start 202, the portable hands-free phone accessory is operating in a low power, or “sleep” mode to conserve battery power because it is not being used in hands-free mode. The portable hands-free phone accessory is designed to turn on for hands-free operation automatically. The transition from low power mode to operating mode is commenced upon detection of a condition indicating the mobile communication device is sufficiently nearby (204). As will be apparent to those skilled in the art, the detection process will involve an algorithmic loop where the portable hands-free phone accessory periodically or occasionally samples ambient conditions, compares the measurements with profiles or thresholds stored in memory which correspond to the presence of a mobile communication device. The portable hands-free phone accessory may then confirm the presence of the mobile communication device, such as by prompting for an input or response (206). Upon determining that the mobile communication device is sufficiently nearby, the portable hands-free phone accessory commences connecting to the mobile communication device (208). Upon successfully connecting, the portable hands-free phone accessory then provides hands-free operation (210). The method continues with the portable hands-free phone accessory providing hands-free operation until a condition occurs which indicates hands-free operation is no longer needed.

In detecting the presence of the mobile communication device (204) there are several conditions which may be periodically monitored by the portable hands-free phone accessory (214). For example, the vibration or sound created by closing a vehicle door may be used to infer the mobile communication device has come in range of the portable hands-free phone accessory. In another embodiment, the portable hands-free phone accessory periodically monitors the PAN medium for a probe signal from the mobile communication device. Upon detecting the signal, and the identifier used by the mobile communication device, the portable hands-free phone accessory determines the strength of the signal being received. The portable hands-free phone accessory may compare the received signal strength to a threshold, or check its own transmit power level needed to maintain a PAN link as evidence that the mobile communication device is nearby.

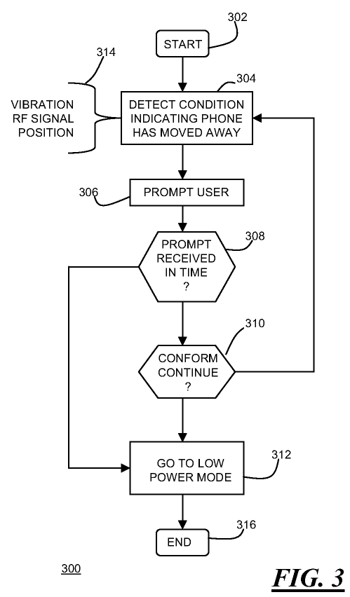

Referring now to FIG. 3, there is shown a flow chart diagram 300 of a method of operating a portable hands-free phone accessory, in accordance with an embodiment of the invention. The present method starts 302 with the portable hands-free phone accessory in an operating mode, providing hands-free service to a mobile communication device with which it is linked. The portable hands-free phone accessory may be located in a vehicle. At some time, the user of the mobile communication device moves away from the portable hands-free phone accessory. Accordingly, the portable hands-free phone accessory detects a condition indicating the mobile communication device has been moved away (304). As indicated previously herein, there are a variety of parameters (314) which the portable hands-free phone accessory may monitor in determining that the mobile communication device has moved sufficiently away that it may be assumed hands-free operation is no longer needed. These include, but are not limited to, sensing a vibration corresponding to a vehicle door closing, detecting a sound corresponding to a vehicle door closing, receiving positioning or location information from the mobile communication device indicating the mobile communication device has moved away, the received signal strength of the PAN link, and so on. Upon detecting a condition indicating the mobile communication device has moved away, the portable hands-free phone accessory may prompt for a response 306 from the user. Prompting allows the portable hands-free phone accessory to confirm that the user has left the vicinity of the portable hands-free phone accessory when no response is received. Decision box 308 indicates that, after providing the prompt (306), the portable hands-free phone accessory waits for a period of time to receive a response. If a response is received, the portable hands-free phone accessory may confirm that the user wishes to cease or continue hands-free operation (310). If a response is not received in time, or if the response indicates the user wishes to cease hands-free operation, the portable hands-free phone accessory ceases hands-free operation and goes to a battery saving low power mode 312. If the user responds to the prompt indicating a desire to continue hands-free operation, such as if the condition detected in box 304 was a false condition, then the portable hands-free phone accessory returns to monitoring conditions to detect any indication of the mobile communication device moving away from the portable hands-free phone accessory (304). The method ends with the portable hands-free phone accessory in low power mode 314, which may be the start of the method illustrated in FIG. 2.

In detecting a condition indicating the mobile communication device has moved away from the portable hands-free phone accessory (304), as mentioned, there are a variety of conditions which may be monitored. The portable hands-free phone accessory may monitor any one of them or a combination of them. For example, a vibration or sound corresponding to that cause by a vehicle door closing may be detected. The portable hands-free phone accessory may also monitor signal strength, directly or indirectly, of the wireless link between the portable hands-free phone accessory and the mobile communication device. The portable hands-free phone accessory may monitor received signal strength, or it may monitor the transmit power level used by the portable hands-free phone accessory's PAN controller. If the PAN transmitter has or is increasing transmit power, it may be due to the mobile communication device moving away from the portable hands-free phone accessory. To reduce a false detection due to a momentary change in signal strength, the portable hands-free phone accessory may keep a running average of signal strength or transmit power by periodically sampling and maintaining a buffer of the most recent samples, and averaging their values together. The running average may then be compared to a threshold which has been determined to indicate that the mobile communication device has been moved away from the portable hands-free phone accessory. In addition to signal strength, the portable hands-free phone accessory may also monitor the occurrence of the PAN link dropping and reconnecting, as may occur when the mobile communication device is moving in and out of range of the portable hands-free phone accessory, but is still close enough that average signal strength doesn't drop below a preselected threshold. It is also contemplated that the portable hands-free phone accessory may receive location information from the mobile communication device, assuming the mobile communication device is equipped to determine its location. The location of the mobile communication device, as reported to the portable hands-free phone accessory by the mobile communication device, may be compared to its own location, if the portable hands-free phone accessory has a location determination means, or it may be compared to information generated by the accelerometer. If the location reading of the respective devices differ, or if the location of the mobile communication device is changing and the accelerometer in the portable hands-free phone accessory indicates it is not moving, then a determination that the mobile communication device has moved away from the portable hands-free phone accessory may be made, and the user prompted to confirm or reverse that determination.

This invention can be embodied in other forms without departing from the spirit or essential attributes thereof. Accordingly, reference should be made to the following claims, rather than to the foregoing specification, as indicating the scope of the invention.

What is claimed is:

1. A method for operating a portable hands-free phone accessory, comprising:
while the portable hands-free phone accessory is not connected to a phone and is operating in a low power mode, detecting at least one of a vibration of the portable hands-free phone accessory or a personal area network signal from a mobile communication device, wherein the vibration corresponds to a vehicle door closing, and the personal area network signal correspond to a mobile communication device which has been previously paired with the portable hands-free phone accessory;
powering up the portable hands-free phone accessory to an initial operating mode;
connecting to a mobile communication device over a wireless personal area radio link; and
providing hands-free phone operation for the mobile communication device.

2. A method for operating a portable hands-free phone accessory as defined in claim 1, wherein connecting to the mobile communication device comprises detecting a personal area network signal transmitted by the mobile communication device which identifies the mobile communication device.

3. A method for operating a portable hands-free phone accessory as defined in claim 2, wherein the mobile communication device has been previously paired with the portable hands-free phone accessory.

4. A method for operating a portable hands-free phone accessory as defined in claim 1, wherein detecting the vibration comprises measuring a momentary acceleration of the portable hands-free phone accessory and comparing the momentary acceleration to one of an acceleration profile or an acceleration threshold.

5. A method for operating a portable hands-free phone accessory as defined in claim 1, further comprising: upon detecting the vibration, prompting for a user to respond before connecting to the mobile communication device.

6. A method for operating a portable hands-free phone accessory as defined in claim 5, wherein prompting is performed using synthesized voice prompt.

7. A method for operating a portable hands-free phone accessory as defined in claim 5, further comprising receiving an input from the user and wherein the input causes the portable hands-free phone accessory to commence connecting with the mobile communication device.

8. A method for operating a portable hands-free phone accessory as defined in claim 7, wherein the input is a spoken input provided by the user, and wherein the portable hands-free phone accessory recognizes the spoken input using speech recognition.

9. A method for operating a portable hands-free phone accessory as defined in claim 7, wherein the input is an actuation of a button of the portable hands-free phone accessory.

10. A method for operating a portable hands-free phone accessory, comprising:
providing hand-free operation for an mobile communication device to which the portable hands-free phone accessory is wirelessly connected via a personal area network link;
detecting the occurrence of a condition indicating the mobile communication device has moved away from the portable hands-free phone accessory outside of a range corresponding to a vehicle cabin range; and
powering the portable hands-free phone accessory down from an operating power level to a low power level.

11. A method for operating a portable hands-free phone accessory as defined in claim 10, wherein detecting the occurrence of the condition indicating the mobile communication device has moved away from the portable hands-free phone accessory comprises detecting a vibration at the portable hands-free phone accessory, wherein the vibration corresponds to a vehicle door closing and wherein the hands-free phone accessory is located inside the vehicle.

12. A method for operating a portable hands-free phone accessory as defined in claim 11, wherein detecting the vibration comprises measuring a momentary acceleration of the portable hands-free phone accessory and comparing the momentary acceleration to one of an acceleration profile or an acceleration threshold.

13. A method for operating a portable hands-free phone accessory as defined in claim 11, further comprising: upon detecting the vibration, prompting for a user to respond before powering down to the low power level, and commencing with powering down after not receiving a response within a pre-selected time period.

14. A method for operating a portable hands-free phone accessory as defined in claim 13, wherein prompting is performed using a synthesized voice prompt.

15. A method for operating a portable hands-free phone accessory as defined in claim 10, wherein detecting the occurrence of the condition indicating the mobile communication device has moved away from the portable hands-free phone accessory comprises detecting a drop in a signal strength level of the personal area network link.

16. A method for operating a portable hands-free phone accessory as defined in claim 15, wherein detecting the drop in signal strength comprises measuring a running average of the signal strength.

17. A method for operating a portable hands-free phone accessory as defined in claim 15, wherein detecting the drop in signal strength comprises detecting an increase in transmission power of a transmitter used to maintain the personal area network link.

18. A method for operating a portable hands-free phone accessory as defined in claim 15, wherein detecting the drop in signal strength comprises detecting the signal strength dropping below a threshold level.

19. A method for operating a portable hands-free phone accessory as defined in claim 18, wherein detecting the drop in signal strength comprises detecting the signal strength dropping below the threshold a pre-defined number of times within a pre-selected time period.

20. A method for operating a portable hands-fee phone accessory as defined in claim 10, wherein the mobile communication device comprises a satellite positioning receiver for determining a present location of the mobile communication device, detecting the occurrence of a condition indicating the mobile communication device has moved away from the portable hands-free phone accessory comprises receiving location information from the mobile communication device over the personal area network link.
